(19) United States
(12) Patent Application Publication
(10) Pub. No.: US 2025/0259986 A1
(43) Pub. Date: Aug. 14, 2025

(54) MANUFACTURING METHOD OF PRE-LITHIATED ANODE FOR SOLID-STATE BATTERY

(71) Applicants: Hyundai Motor Company, Seoul (KR); Kia Corporation, Seoul (KR); Kyungpook National University Industry-Academic Cooperation Foundation, Daegu (KR)

(72) Inventors: Ki Yoon Bae, Seoul (KR); Sam Ick Son, Suwon-si (KR); Ji Young Kim, Suwon-si (KR); Ju Hyeon Lee, Daegu (KR); Ji Hoon Lee, Daegu (KR)

(21) Appl. No.: 18/781,462

(22) Filed: Jul. 23, 2024

(30) Foreign Application Priority Data
Feb. 13, 2024 (KR) 10-2024-0020123

(51) Int. Cl. H01M 4/04; H01M 4/02; H01M 4/134; H01M 4/1395; H01M 4/38; H01M 10/052

(52) U.S. Cl. CPC H01M 4/0459; H01M 4/134; H01M 4/1395; H01M 4/382; H01M 10/052; H01M 2004/027

(57) ABSTRACT

An embodiment method of manufacturing a pre-lithiated anode includes preparing an anode assembly including an anode current collector and an intermediate layer disposed on a surface of the anode current collector, wherein the intermediate layer includes silver particles and a carbon material, applying an electrolyte solution to the intermediate layer, manufacturing a pressurization structure by stacking a lithium supply layer on the intermediate layer coated with the electrolyte solution, and performing pre-lithiation to convert the intermediate layer into a coating layer by applying pressure to the pressurization structure in a stacking direction thereof to form the pre-lithiated anode, wherein the coating layer includes a γ₃ phase Li—Ag alloy formed by reacting the silver particles with lithium in performing the pre-lithiation.

### CROSS-REFERENCE TO RELATED APPLICATIONS

This application claims the benefit of Korean Patent Application No. 10-2024-0020123, filed on Feb. 13, 2024, which application is hereby incorporated herein by reference.

### TECHNICAL FIELD

The present disclosure relates to a manufacturing method of a pre-lithiated anode for a solid-state battery.

### BACKGROUND

Recently, in order to solve environmental problems caused by carbon dioxide (CO₂), use of fossil fuels has been avoided, and thus, the automobile industry, which relates to means of transportation, is showing great interest in electric vehicles using secondary batteries. Using currently developed lithium-ion batteries, vehicles may travel about 40 km on a single charge, but problems, such as instability at high temperatures and fire, still exist. To solve these problems, many companies are competitively developing next-generation secondary batteries.

All-solid-state batteries, which are attracting attention as next-generation secondary batteries, have advantages of lower risk of fire and explosion and higher mechanical strength compared to lithium-ion batteries that use flammable organic solvents as electrolytes because all components of the all-solid-state batteries are formed of solids. The all-solid-state battery generally includes a cathode including a cathode active material layer bonded to a cathode current collector, an anode including an anode active material layer bonded to an anode current collector, and a solid electrolyte layer located between the cathode active material layer and the anode active material layer.

The anode active material layer is generally formed by mixing an anode active material, such as graphite, silicon, or the like, with a solid electrolyte so as to ensure lithium-ion conduction, and the conventional all-solid-state battery has a low energy density compared to the lithium-ion battery because solid electrolytes have lower specific gravity than liquid electrolytes.

In order to solve such a problem, a storage-type anodeless all-solid-state battery in which an anode active material layer is removed or only a small amount of an anode active material is used and lithium ions (Li⁺) are directly deposited as lithium metal or a lithium alloy on an anode current collector has been proposed.

In the storage-type anodeless all-solid-state battery, when charging, lithium ions (Li+) are released from a cathode active material layer, and the lithium ions pass through a solid electrolyte layer and cause a reduction reaction with electrons on the surface of the anode current collector to produce lithium metal. The opposite electrochemical reaction occurs when discharging. That is, the anodeless all-solid-state battery may be charged and discharged without an anode active material.

In this regard, it is known that the electrochemical characteristics of the anodeless all-solid-state battery may be improved by inserting a separate layer including silver (Ag), which forms an alloy with lithium, and a carbon material between the solid electrolyte layer and the anode current collector, but there is a problem that initial cycle efficiency is reduced due to an irreversible reaction during an initial charging and discharging process.

The above information disclosed in this background section is only for enhancement of understanding of the background of the disclosure and therefore it may contain information that does not form the already known prior art.

### SUMMARY

The present disclosure relates to a manufacturing method of a pre-lithiated anode for a solid-state battery. Particular embodiments relate to a manufacturing method of a pre-lithiated anode in which a lithium alloy having a specific phase is formed by pre-lithiating a layer including silver (Ag) particles and a carbon material, so as to improve initial cycle efficiency and coulombic efficiency of an all-solid-state battery including the manufactured pre-lithiated anode.

Embodiments of the present disclosure can solve problems associated with the prior art, and embodiments of the present disclosure provide a manufacturing method of a pre-lithiated anode in which initial charge/discharge cycle efficiency and coulombic efficiency of an anodeless all-solid-state battery may be improved while maintaining excellent electrochemical characteristics of the anodeless all-solid-state battery.

The embodiments of the present disclosure are not limited to the above-mentioned embodiments. The embodiments of the present disclosure will become clearer from the following description and may be realized by means stated in the claims and combinations thereof.

An embodiment of the present disclosure may provide a manufacturing method of a pre-lithiated anode, the method including preparing an anode assembly including an anode current collector and an intermediate layer disposed on at least one surface of the anode current collector, applying an electrolyte solution to the intermediate layer, manufacturing a pressurization structure by stacking a lithium supply layer on the intermediate layer coated with the electrolyte solution, and performing pre-lithiation configured to convert the intermediate layer into a coating layer by applying pressure to the pressurization structure in a stacking direction thereof, wherein the intermediate layer may include silver (Ag) particles and a carbon material, and the coating layer may include a γ₃ phase Li—Ag alloy formed by reacting the silver (Ag) particles with lithium in performing the pre-lithiation.

In a preferred embodiment, the electrolyte solution may include a lithium salt and an organic solvent.

In another preferred embodiment, the lithium salt may include a compound selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

In still another preferred embodiment, the organic solvent may include a solvent selected from the group consisting of an ester-based solvent, an ether-based solvent, a ketone-based solvent, an aromatic hydrocarbon-based solvent, a carbonate-based solvent, an alcohol-based solvent, a nitrile-based solvent, an amide-based solvent, a dioxolane-based solvent, a sulfolane-based solvent, and combinations thereof.

In yet another preferred embodiment, an area of the lithium supply layer may be greater than an area of the anode assembly.

In still yet another preferred embodiment, the pressure applied to the pressurization structure may be 0.01 MPa to 0.1 MPa.

In a further preferred embodiment, the pre-lithiation may be performed for 5 hours or more but less than 10 hours. Furthermore, the pre-lithiation may be performed for 5 hours to 7 hours.

In another further preferred embodiment, the pre-lithiation may be performed at room temperature.

In still another further preferred embodiment, the γ₃ phase Li—Ag alloy may be represented by Formula 1 below.

LiₓAg (x being 1.98 to 2.25) Formula 1:

In yet another further preferred embodiment, the γ₃ phase Li—Ag alloy may be irreversibly formed.

In still yet another further preferred embodiment, the coating layer may not include a γ₂ phase Li—Ag alloy and a γ₁ phase Li—Ag alloy.

In a still further preferred embodiment, the carbon material may include at least one carbon material selected from the group consisting of a particulate carbon material, a fibrous carbon material, and a combination thereof.

In a yet still further preferred embodiment, the manufacturing method may further include, after performing the pre-lithiation, collecting a pre-lithiated anode including the anode current collector and the coating layer, removing remaining impurities from the pre-lithiated anode with a washing solvent, and drying the pre-lithiated anode from which the impurities have been removed.

Other aspects and preferred embodiments of the disclosure are discussed infra.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows a manufacturing method of a pre-lithiated anode according to embodiments of the present disclosure;

FIG. 2 shows a process of forming an Li—Ag alloy in a pre-lithiation process according to embodiments of the present disclosure;

FIG. 3 shows an all-solid-state battery including the anode manufactured according to embodiments of the present disclosure;

FIG. 4 shows a phase diagram of the Li—Ag alloy;

FIG. 5 shows in-situ XRD results measured by applying voltage or current during a manufacturing process of an anode according to a Comparative Preparation Example;

FIG. 6 shows in-situ XRD results measured by applying voltage or current during a manufacturing process of an anode according to a Preparation Example;

FIG. 7 shows XRD results of anodes manufactured by adjusting a pre-lithiation time;

FIG. 8 shows initial charge/discharge results of a coin cell manufactured according to a Comparative Example;

FIG. 9 shows initial charge/discharge results of coin cells manufactured according to an Example; and

FIG. 10 shows coulombic efficiencies of the coin cells manufactured according to an Example.

It should be understood that the appended drawings are not necessarily to scale, presenting a somewhat simplified representation of various preferred features illustrative of the basic principles of embodiments of the disclosure. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the accompanying drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising”, and “having”, are to be interpreted as indicating the presence of characteristics, numbers, steps, operations, elements, or parts stated in the description or combinations thereof, and they do not exclude the presence of one or more other characteristics, numbers, steps, operations, elements, parts, or combinations thereof, or the possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description are approximations in which various uncertainties in measurement generated when these values are obtained from essentially different things are reflected, and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

It is known that the electrochemical characteristics of a storage-type anodeless all-solid-state battery in which an anode active material layer is removed or only a small amount of an anode active material is used and lithium ions (Li⁺) are directly deposited as a lithium metal or a lithium alloy on an anode current collector are improved by inserting a separate layer including silver (Ag), which forms an alloy with lithium, and a carbon material between a solid electrolyte layer and the anode current collector. However, this technology has a problem that initial cycle efficiency is reduced due to an irreversible reaction during an initial charging and discharging process.

Embodiments of the present disclosure can solve this problem. Pre-lithiation of an anode is performed before assembling the all-solid-state battery 1′, and the initial charge and discharge efficiency of the all-solid-state battery 1′ may be increased by manufacturing the all-solid-state battery 1′ using the anode which has undergone the pre-lithiation process. This will be described in more detail below.

### Manufacturing Method of a Pre-Lithiated Anode

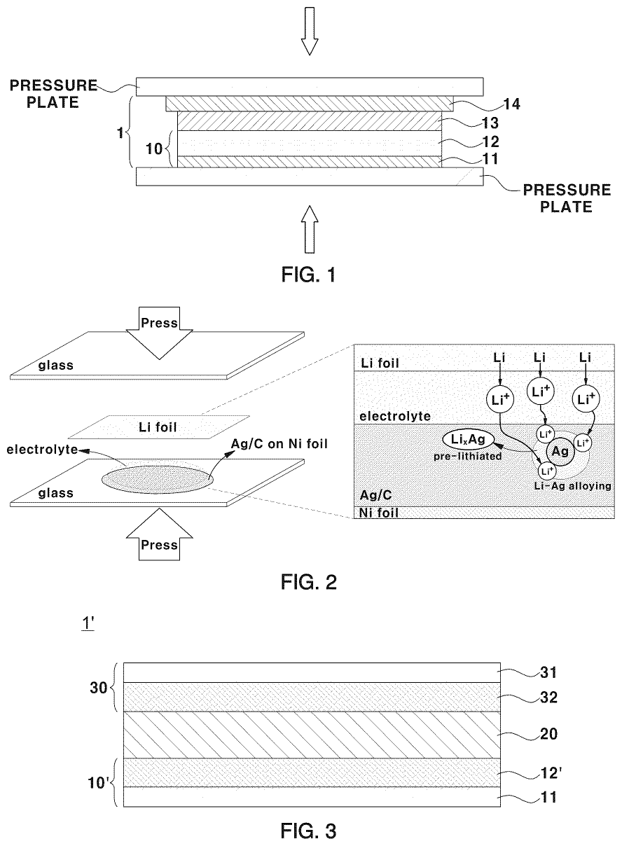

FIG. 1 shows a pressurization structure 1 configured to manufacture a pre-lithiated anode 10′ according to embodiments of the present disclosure and a pressing process executed to manufacture the pre-lithiated anode 10′. FIG. 2 shows a process of forming an Li—Ag alloy in a pre-lithiation process according to embodiments of the present disclosure. Further, FIG. 3 shows the all-solid-state battery 1′ including the pre-lithiated anode 10′ manufactured according to the manufacturing method of embodiments of the present disclosure.

Referring to FIGS. 1 and 2, the manufacturing method of the lithiated anode 10′ may include preparing an anode assembly 10 including the anode current collector 11 and an intermediate layer 12 disposed on at least one surface of the anode current collector 11, applying an electrolyte solution 13 to the intermediate layer 12, manufacturing the pressurization structure 1 by stacking a lithium supply layer 14 on the intermediate layer 12 coated with the electrolyte solution 13, and performing pre-lithiation configured to convert the intermediate layer 12 into a coating layer 12′ by applying pressure to the pressurization structure 1 in the stacking direction thereof.

First, the intermediate layer 12 may be stacked on at least one surface, preferably any one surface, of the anode current collector 11. Here, the intermediate layer 12 may include silver (Ag) particles and the carbon material. The silver (Ag) particles may be understood as silver (Ag) in a powder form and may form an alloy with lithium in a pre-lithiation operation which will be described later.

Further, the carbon material may include a carbon material selected from the group consisting of a particulate carbon material, a fibrous carbon material, and a combination thereof.

The particulate carbon material may include a carbon material selected from the group consisting of carbon black, easy-graphitizable carbon (i.e., soft carbon), non-graphitizable carbon (i.e., hard carbon), and combinations thereof. The particle diameter of the particulate carbon material is not particularly limited, and may be, for example, 10 nm to 200 nm.

Further, the fibrous carbon material may include a carbon material selected from the group consisting of carbon nanofibers, carbon nanotubes, vapor grown carbon fibers, and combinations thereof. The cross-sectional diameter of fibers of the fibrous carbon material is not particularly limited, and may be, for example, 10 nm to 200 nm.

In one embodiment, a method of stacking the intermediate layer 12 on the anode current collector 11 may use a conventional technique which is used in the relevant technical field. For example, a slurry may be prepared by putting powder including the silver particles and the carbon material into an organic solvent and mixing the same. Thereafter, the intermediate layer 12 may be stacked on the anode current collector 11 by applying the slurry to the anode current collector 11 and then drying the slurry.

In one embodiment, the anode current collector 11 may include a material which does not react with lithium. Specifically, the anode current collector 11 may include at least material selected from the group consisting of nickel (Ni), copper (Cu), stainless steel, and combinations thereof.

The thickness of the anode current collector 11 is not particularly limited, and may be, for example, 1 μm to 500 μm.

After preparing the anode assembly 10 including the intermediate layer 12 stacked on the anode current collector 11 through the above process, the electrolyte solution 13 may be applied to the intermediate layer 12.

The electrolyte solution 13 may include a material having high lithium-ion conductivity, and for example, the electrolyte solution 13 may include a lithium salt and an organic solvent.

The lithium salt may be any compound which may provide lithium ions without being particularly limited. For example, the lithium salt may include a compound selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

The concentration of the lithium salt may be preferably within the range of 0.1 M to 2.0 M. When the concentration of the lithium salt is within the above range, the electrolyte solution 13 has appropriate conductivity and viscosity, and it may thus exhibit excellent electrolyte performance and enable effective movement of lithium ions.

Any material may be used as the organic solvent without being particularly limited, as long as it may serve as a medium through which ions involved in the electrochemical reaction of the battery may move. For example, the organic solvent may include a solvent selected from the group consisting of an ester-based solvent, an ether-based solvent, a ketone-based solvent, an aromatic hydrocarbon-based solvent, a carbonate-based solvent, an alcohol-based solvent, a nitrile-based solvent, an amide-based solvent, a dioxolane-based solvent, a sulfolane-based solvent, and combinations thereof.

Specifically, the organic solvent may include an ester-based solvent, such as methyl acetate, ethyl acetate, γ-butyrolactone, or ε-caprolactone, an ether-based solvent, such as dibutyl ether or tetrahydrofuran, a ketone-based solvent, such as cyclohexanone, an aromatic hydrocarbon-based solvent, such as benzene or fluorobenzene, a carbonate-based solvent, such as dimethylcarbonate (DMC), diethylcarbonate (DEC), methylethylcarbonate (MEC), ethylmethylcarbonate (EMC), ethylene carbonate (EC), or propylene carbonate (PC), an alcohol-based solvent, such as ethyl alcohol or isopropyl alcohol, a nitrile-based solvent, such as R—CN (R being a straight-chain, branched, or ring-structure hydrocarbon group having 2 to 20 carbon atoms and including a double bond aromatic ring or an ether bond), an amide-based solvent, such as dimethylformamide, a dioxolane-based solvent, such as 1,3-dioxolane, or a sulfolane-based solvent.

Among these, a carbonate-based solvent is preferable, and a mixture of a cyclic carbonate (for example, ethylene carbonate, propylene carbonate, or the like) having high ionic conductivity and a high dielectric constant which may improve charge/discharge performance of the battery and a low-viscosity chain carbonate (for example, ethylmethyl carbonate, dimethyl carbonate, diethyl carbonate, or the like) is more preferable. In this case, the performance of the electrolyte solution 13 may be excellent when the cyclic carbonate and the chain carbonate are mixed in a volume ratio of about 1:1 to about 1:9.

The pressurization structure 1 may be manufactured by stacking the lithium supply layer 14 on the intermediate layer 12 coated with the electrolyte solution 13, after applying the electrolyte solution 13 to the intermediate layer 12. The lithium supply layer 14 provides lithium ions to the intermediate layer 12 in the pre-lithiation operation which will be described later, and may include, for example, lithium (Li) foil.

Here, the area of the lithium supply layer 14 may be greater than or equal to the area of the anode assembly 10. As shown in FIGS. 1 and 2, the area of the lithium supply layer 14 is greater than or equal to the area of the anode assembly 10 so as to cover the entirety of an area where the anode assembly 10 is located, thereby allowing the pre-lithiation operation to be more effectively performed.

Thereafter, the intermediate layer 12 may be converted into the coating layer 12′ by applying pressure to the pressurization structure 1 in the stacking direction thereof. The meaning of “conversion” may indicate a series of processes of forming the Li—Ag alloy through a reaction between the silver (Ag) particles in the intermediate layer 12 and lithium ions released from the lithium supply layer 14 or lithium ions moved through the electrolyte solution 13.

Therefore, the coating layer 12′ may include the Li—Ag alloy formed through the reaction between the silver (Ag) particles and lithium in the pre-lithiation operation.

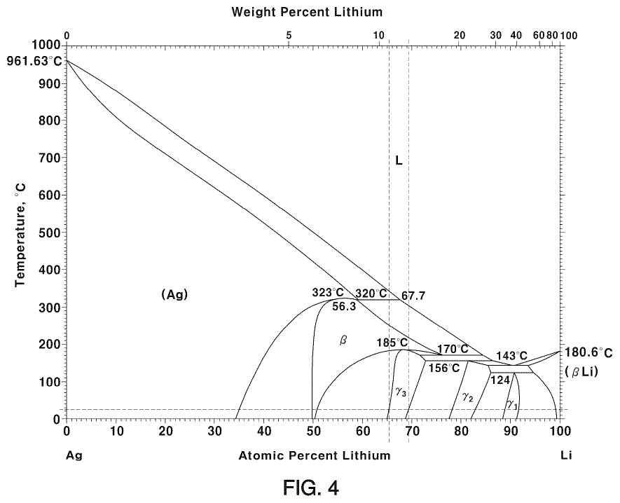

This will be described in more detail with reference to a phase diagram of the Li—Ag alloy. FIG. 4 shows the phase diagram of the Li—Ag alloy.

Referring to FIG. 4, the Li—Ag alloy may exist in the silver (Ag) phase, the β phase, the γ₃ phase, the γ₂ phase, the γ₁ phase, and a mixed state thereof, in a temperature range of about 124° C. or less. In addition, based on room temperature, the silver (Ag) phase may appear when the lithium (Li) content is 0%-35.0%, the β phase may appear when the lithium (Li) content is 49%-51%, the γ₃ phase may appear when the lithium (Li) content is 66.5%-69.1%, the γ₂ phase may appear when the lithium (Li) content is 78%-83%, and the γ₁ phase may appear when the lithium (Li) content is 89%-92%.

Referring to this, in the Li—Ag alloy, as the content of lithium (Li) forming an alloy with silver (Ag) increases, the alloy may undergo phase transition of the silver (Ag) phase→the β phase→the γ₃ phase→the γ₂ phase→the γ₁ phase.

Here, it is preferable for the Li—Ag alloy according to embodiments of the present disclosure to have the γ₃ phase. In the coating layer 12′ including the γ₃ phase Li—Ag alloy, and the pre-lithiated anode 10′ including the same, the γ₃ phase Li—Ag alloy may not return to silver (Ag) particles even if the battery is charged and discharged several times. That is, the γ₃ phase Li—Ag alloy in the coating layer 12′ may be formed irreversibly.

In a conventional anodeless all-solid-state battery including a coating layer which is not pre-lithiated, i.e., the intermediate layer 12, lithium is consumed due to the γ₃ phase Li—Ag alloy which is formed irreversibly while charging and discharging the battery, thereby being capable of reducing initial charge/discharge efficiency. According to embodiments of the present disclosure, the γ₃ phase Li—Ag alloy, which is irreversibly formed as above, is prepared in advance through pre-lithiation before assembling the all-solid-state battery 1′, and thereafter, the all-solid-state battery 1′ is assembled, thereby being capable of minimizing the amount of lithium consumed during initial charging and discharging.

In addition, it is preferable that the coating layer 12′ not include the γ₁ phase Li—Ag alloy and the γ₂ phase Li—Ag alloy. In the γ₁ phase Li—Ag alloy and the γ₂ phase Li—Ag alloy, Li has already formed an alloy with Ag at a relatively high ratio. Therefore, when the coating layer 12′ includes the γ₁ phase Li—Ag alloy and the γ₂ phase Li—Ag alloy, an additional lithium alloy may not be formed when charging the all-solid-state battery 1′ after assembling the all-solid-state battery 1′, and thus, it may be difficult for the all-solid-state battery 1′ to function as an anodeless battery.

In one embodiment, the γ₃ phase Li—Ag alloy may be expressed as Li₈Ag₅ to Li₉Ag₄. Preferably, the γ₃ phase Li—Ag alloy may be represented by Formula 1 below.

LiₓAg (x being 1.98 to 2.25) Formula 1:

However, the value of x is based on the phase diagram shown in FIG. 4, and the value of x may become slightly different if the binary Li—Ag phase diagram becomes more sophisticated with development of technology.

According to embodiments of the present disclosure, the degree of phase transition of the Li—Ag alloy may be adjusted by performing pre-lithiation in the state in which a designated pressure is applied to the pressurization structure 1. In one embodiment, the pressure applied to the pressurization structure 1 may be 0.01 MPa to 0.1 MPa. When the pressure of 0.01 MPa to 0.1 MPa is applied to the pressurization structure 1, the γ₃ phase Li—Ag alloy may be formed.

When a pressure of less than 0.01 MPa is applied to the pressurization structure 1, an Li—Ag alloying speed is relatively high, the phase transition of the Li—Ag alloy may proceed beyond the γ₃ phase to the γ₂ phase and the γ₁ phase. On the other hand, when a pressure exceeding 0.1 MPa is applied to the pressurization structure 1, an Li—Ag alloying speed is excessively low, and thus, a time required for pre-lithiation may be increased and efficiency of the process may be reduced.

In the process of converting the intermediate layer 12 into the coating layer 12′ according to the manufacturing method of embodiments of the present disclosure, the content of lithium (Li) included in the Li—Ag alloy may increase due to movement of lithium ions. Accordingly, the Li—Ag alloy in the coating layer 12′ may undergo phase transition of the silver (Ag) phase→the β phase→the γ₃ phase.

In one embodiment, the pre-lithiation may be performed for 5 hours or more but less than 10 hours. Preferably, the pre-lithiation may be performed for 5 to 7 hours.

When the pre-lithiation is performed for less than 5 hours, the γ₃ phase Li—Ag alloy in the coating layer 12′ may not be sufficiently formed. When the pre-lithiation time is 10 hours or more, the phase transition of the Li—Ag alloy may proceed beyond the γ₃ phase to the γ₂ phase and the γ₁ phase. When the pre-lithiation is performed for 5 to 7 hours, the initial cycle efficiency and coulombic efficiency of the all-solid-state battery 1′ due to the pre-lithiation may be improved and process efficiency may be improved in a balanced manner.

In one embodiment, the pre-lithiation may be performed at room temperature. By performing the pre-lithiation at room temperature, costs may be reduced compared to the case in which the pre-lithiation is performed at temperatures other than room temperature.

Meanwhile, a method of applying pressure to the pressurization structure 1 in the stacking direction thereof is not particularly limited, and for example, pressure may be applied to the pressurization structure 1 through a method of pressing pressure plates after attaching the pressure plates, such as glass plates, to upper and lower surfaces of the pressurization structure 1.

In one embodiment, the pre-lithiation operation may be performed without applying a separate voltage. The intermediate layer 12 is converted into the coating layer 12′ including the γ₃ phase Li—Ag alloy without applying a separate voltage, thereby being capable of reducing energy input in the pre-lithiation process.

In addition, after performing the pre-lithiation, the manufacturing method may further include collecting the pre-lithiated anode 10′ including the anode current collector 11 and the coating layer 12′, removing remaining impurities from the pre-lithiated anode 10′ with a washing solvent, and drying the pre-lithiated anode 10′ from which the impurities have been removed.

Specifically, after performing the pre-lithiation, the pressure plates attached to the upper and lower surfaces of the pressurization structure 1 may be removed, and the pre-lithiated anode 10′ excluding the lithium supply layer 14 and the electrolyte solution 13 from the pressurization structure 1 may be collected.

The impurities, such as the electrolyte solution 13, may remain on the surface of the pre-lithiated anode 10′, and the impurities may be removed with the washing solvent, such as dimethyl carbonate. In addition to dimethyl carbonate, other materials which may dissolve and easily remove the impurities may be used without being particularly limited.

Thereafter, the washing solvent may be removed by drying the pre-lithiated anode 10′ under vacuum. Here, the drying may be carried out at room temperature for about 1 hour, but drying conditions are not particularly limited as long as the washing solvent may be removed.

Manufacturing Method of an all-Solid-State Battery

FIG. 3 shows the all-solid-state battery 1′ including the pre-lithiated anode 10′ according to embodiments of the present disclosure. Referring to this figure, the all-solid-state battery 1′ according to embodiments of the present disclosure may include the pre-lithiated anode 10′ manufactured by the manufacturing method according to embodiments of the present disclosure, the solid electrolyte layer 20 disposed on the pre-lithiated anode 10′ and including a solid electrolyte, and a cathode 30 including a cathode active material layer 32 including a cathode active material and a cathode current collector 31.

The pre-lithiated anode 10′ is substantially the same as the pre-lithiated anode 10′ described in the above “manufacturing method of a pre-lithiated anode”, and a redundant description thereof will thus be omitted.

In one embodiment, the solid electrolyte layer 20 may be located between the cathode active material layer 32 and the coating layer 12′ and may include the solid electrolyte having lithium-ion conductivity.

The solid electrolyte may include an oxide-based solid electrolyte, a sulfide-based solid electrolyte, or the like. A sulfide-based solid electrolyte having high lithium-ion conductivity may preferably be used as the solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, without being particularly limited.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The cathode active material layer 32 may include the cathode active material, a solid electrolyte, a conductive material, a binder, and the like. The cathode active material may intercalate and deintercalate lithium ions thereinto and therefrom, and it may include a rocksalt layer-type active material, such as LiCoO₂, LiMnO₂, LiNiO₂, LiVO₂, or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄, or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), lithium titanate, such as Li₄Ti₅O₁₂, or the like.

The solid electrolyte may include an oxide-based solid electrolyte, a sulfide-based solid electrolyte, or the like. A sulfide-based solid electrolyte having high lithium-ion conductivity may preferably be used as the solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂—LiₓMO_{y} (x and y being positive numbers, and M being one of P, Si, Ge, B, Al, Ga and In), Li₁₀GeP₂S₁₂, or the like, without being particularly limited. The solid electrolyte included in the cathode active material layer 32 may be the same as or different from the solid electrolyte included in the solid electrolyte layer 20.

The conductive material may include carbon black, conductive graphite, ethylene black, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The cathode current collector 31 may include a plate-type substrate having electrical conductivity. The cathode current collector 31 may include aluminum foil.

The thickness of the cathode current collector 31 may be, for example, 1 μm to 500 μm, without being particularly limited.

Hereinafter, embodiments of the present disclosure will be described in more detail through the following Examples and Comparative Examples. The following Examples and Comparative Examples serve merely to exemplarily describe embodiments of the present disclosure and are not intended to limit the scope and spirit of the disclosure.

### PREPARATION EXAMPLE

(1) A slurry was prepared by putting silver (Ag) powder, Super C as a particulate carbon material, and polyvinylidene fluoride (PVDF) as a binder into N-methyl-2-pyrrolidone (NMP) as an organic solvent. An intermediate layer was formed by applying the slurry to a nickel thin film which is an anode current collector and drying the slurry. Here, the intermediate layer was circular, and the diameter thereof was set to 10 mm.

(2) An electrolyte solution was applied to an anode assembly including the anode current collector and the intermediate layer. The electrolyte solution had a composition of 1.15 M LiPF₆ in EC/EMC (v:v=3:7) with 10 wt % of fluoroethylene carbonate (FEC).

(3) Lithium (Li) foil having a larger area than the diameter of the anode assembly was prepared as a lithium supply layer. The lithium foil was located to cover the entirety of the intermediate layer of the anode assembly.

(4) After placing a pressurization structure including the anode assembly, the electrolyte solution, and the lithium supply layer on a glass plate, another glass plate was stacked on the upper surface of the pressurization structure as a pressure plate. Thereafter, pre-lithiation was performed by applying a designated pressure to the pressurization structure by pressing the lower glass plate and the upper glass plate.

Here, the pressure applied to the pressurization structure was 0.05 MPa, and the pre-lithiation was performed at room temperature for 5 hours.

(5) The pressure applied to the pressurization structure was removed, and the anode assembly was collected. Thereafter, the anode assembly was washed with dimethyl carbonate as a solvent, and then the solvent was removed by drying the anode assembly at room temperature under vacuum for 1 hour. Through this process, a pre-lithiated anode was manufactured.

### COMPARATIVE PREPARATION EXAMPLE

A pre-lithiated anode was manufactured through the same process as in the above Preparation Example, except that pre-lithiation was performed without applying a separate pressure to the pressurization structure.

### Test Example 1

In order to confirm a difference in the phase of Li—Ag alloy depending on the pressure applied when performing pre-lithiation, the pre-lithiated anodes manufactured by performing the pre-lithiation according to the Preparation Example and the Comparative Preparation Example were analyzed through in-situ XRD while applying voltage and current.

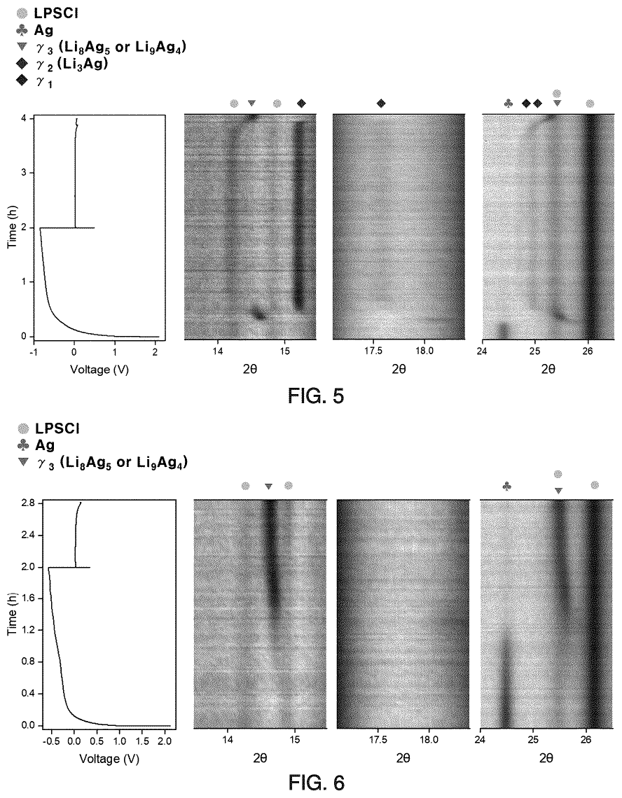

FIG. 5 shows in-situ XRD results of the pre-lithiated anode according to the Comparative Preparation Example, and FIG. 6 shows in-situ XRD results of the pre-lithiated anode according to the Preparation Example. Here, the pre-lithiation, which was carried out by applying voltage and current, was performed at a current density of 0.5 C (0.5 mAcm⁻²) and a cut-off condition of 1 mAhcm⁻² (or 0.15 V).

Referring to FIG. 5 showing the in-situ XRD results of the anode assembly including the pre-lithiated anode according to the Comparative Preparation Example, during the pre-lithiation reaction, the silver (Ag) peak completely disappeared and the γ₃ phase Li—Ag alloy peak appeared, and thereby, it was confirmed that all silver (Ag) particles included in the intermediate layer participated in alloying with lithium and thus the intermediate layer was converted into a coating layer.

Further, it was confirmed that the γ₃ phase Li—Ag alloy peak disappeared and the γ₂ phase Li—Ag alloy peak appeared, and thereafter, some amount of the γ₂ phase Li—Ag alloy underwent phase transition to the γ₁ phase and thus the γ₁ phase Li—Ag alloy peak was observed. Here, the LPSCl peak which appeared vertically is a peak caused by the solid electrolyte.

Referring to FIG. 6 showing the in-situ XRD results of the anode assembly including the pre-lithiated anode according to the Preparation Example, during the pre-lithiation reaction, the silver (Ag) peak completely disappeared and the γ₃ phase Li—Ag alloy peak appeared, and thereby, it was confirmed that all silver (Ag) particles included in the intermediate layer participated in alloying with lithium and thus the intermediate layer was converted into a coating layer.

However, in the anode assembly including the pre-lithiated anode according to the Preparation Example, after the γ₃ phase Li—Ag alloy peak appeared, the γ₂ phase Li—Ag alloy peak and the γ₁ phase Li—Ag alloy peak were not observed. In addition, it was confirmed that Li—Ag alloying occurs slowly through the fact that the section where the silver (Ag) peak is observed is longer than that of the Comparative Preparation Example.

From the above results, it was confirmed that both Li—Ag alloying and Li electrodeposition, in which lithium (Li) metal is deposited on the anode current collector, occur in the anode assemblies according to the Preparation Example and the Comparative Preparation Example, Li electrodeposition acts more dominantly than Li—Ag alloying in the anode assembly according to the Preparation Example, and Li—Ag alloying acts more dominantly than Li electrodeposition in the anode assembly according to the Comparative Preparation Example.

Specifically, referring again to FIG. 4, which is the phase diagram of Li—Ag binary alloy, the γ₃ phase Li—Ag alloy appears when the lithium (Li) content is about 66.5%-69.1%, the γ₂ phase Li—Ag alloy appears when the lithium (Li) content is about 78%-83%, and the γ₁ phase Li—Ag alloy appears when the lithium (Li) content is about 89%-92%.

That is, in the Preparation Example, the alloying reaction proceeds until the lithium (Li) content is about 69%, but in the Comparative Preparation Example, the alloying reaction proceeds until the lithium (Li) content is about 92%, and a large amount of lithium participates in the alloying reaction. Therefore, it is predicted that Li electrodeposition acts more dominantly than Li—Ag alloying in the pre-lithiation process of the anode assembly according to the Preparation Example, and Li—Ag alloying acts more dominantly than Li electrodeposition in the pre-lithiation process of the anode assembly according to the Comparative Preparation Example.

### Test Example 2

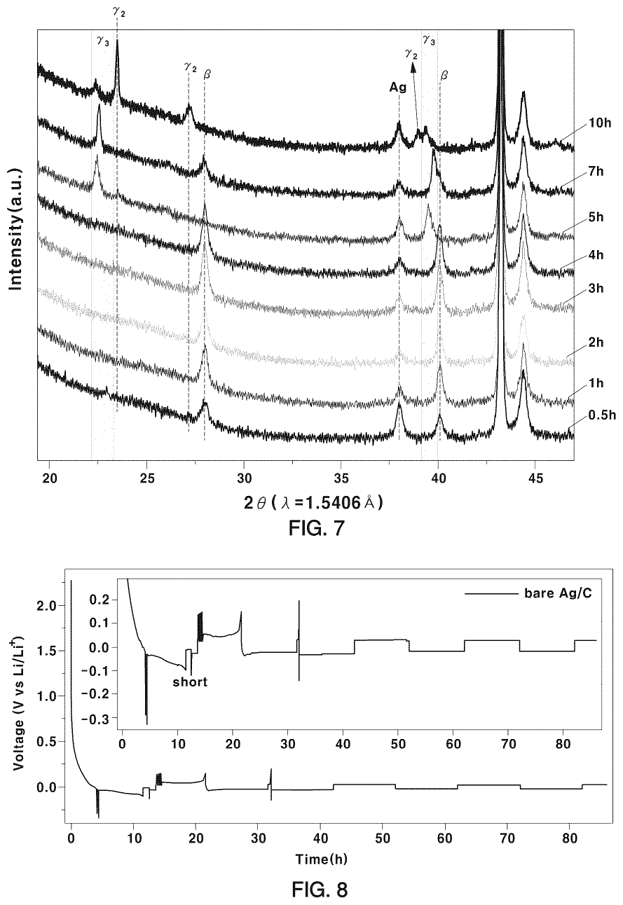

In order to confirm phase transition behavior of the Li—Ag alloy depending on the pre-lithiation time, anode assemblies including pre-lithiated anodes were manufactured using the manufacturing method according to the Preparation Example by varying a time taken to apply pressure to the pressurization structure. After the anode assemblies were manufactured by varying the pre-lithiation time, the pre-lithiated anodes were separated from the anode assemblies, and XRD analysis of the respective pre-lithiated anodes was performed. XRD results of the pre-lithiated anodes are shown in FIG. 7.

Referring to FIG. 7, when the pre-lithiation time was less than 5 hours, only the Ag phase and the β phase were observed. The γ₃ phase was observed from when the pre-lithiation proceeded for 5 hours or more. Further, the γ₃ phase Li—Ag alloy peak became faint and the γ₂ phase Li—Ag alloy peak began to be observed. This is predicted to be because the Li—Ag alloy in the γ₃ phase transitioned to the γ₂ phase.

### EXAMPLE

(1) A solid electrolyte layer was manufactured by putting 80 mg of lithium phosphorus sulfur chloride (LPSCl), which is a sulfide-based solid electrolyte, into a cylindrical mold and then applying a pressure of 70 MPa for 5 seconds. Here, the diameter of the solid electrolyte layer was about 10.1 mm.

(2) Compacted powder was manufactured by putting the pre-lithiated anode manufactured according to the Preparation Example and the solid electrolyte layer into a coin cell mold and then applying a pressure of 500 MPa for 20 seconds.

(3) After the compacted powder was aligned at the center of a coin cell case, a gasket, lithium metal, a spacer, a plurality of springs, and a cap were assembled in order therewith. The lithium metal had a diameter of 10 mm and a thickness of 300 μm, and the spacer had a thickness of 1 mm. Thereafter, a coin cell was manufactured by applying a stack pressure of 0.6 MPa to the coin cell case. Although the stack pressure of 0.6 MPa is applied in the Example, a pressure lower than this value may be applied.

### COMPARATIVE EXAMPLE

(1) A slurry was prepared by putting silver (Ag) powder, Super C as a particulate carbon material, and polyvinylidene fluoride (PVDF) as a binder into N-methyl-2-pyrrolidone (NMP) as an organic solvent. An anode including an Ag/C layer formed on an anode current collector was manufactured by applying the slurry to a nickel thin film serving as the anode current collector and drying the slurry.

(2) A solid electrolyte layer was manufactured by putting 80 mg of lithium phosphorus sulfur chloride (LPSCl), which is a sulfide-based solid electrolyte, into a cylindrical mold and then applying a pressure of 70 MPa for 5 seconds. Here, the diameter of the solid electrolyte layer was about 10.1 mm.

(3) Compacted powder was manufactured by putting the manufactured anode and the solid electrolyte into a coin cell mold and then applying a pressure of 500 MPa for 20 seconds.

(4) After the compacted powder was aligned at the center of a coin cell case, a gasket, lithium metal, a spacer, two springs, and a cap were assembled in order therewith. The lithium metal had a diameter of 10 mm and a thickness of 300 μm, and the spacer had a thickness of 1 mm. Thereafter, a coin cell was manufactured by applying a stack pressure of 0.6 MPa to the coin cell case.

### Test Example 3—Electrochemical Characteristic Analysis

In order to detect initial cycle efficiencies of the coin cells according to the Example and the Comparative Example, an initial charge and discharge test was performed on the coin cells. Charging and discharging were performed under the conditions of 2 mAh/cm², 0.15 V, and current density of 0.1 mA/cm² after a cut-off voltage of 0 V.

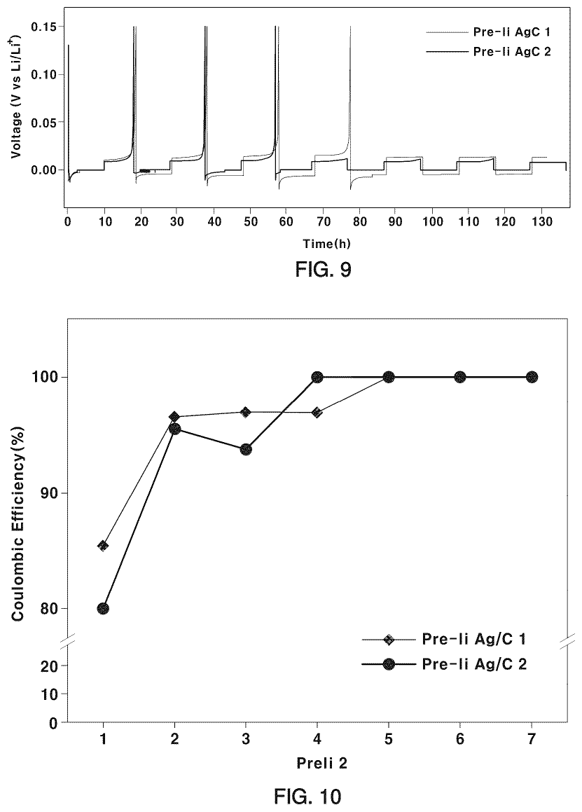

The results of the coin cell according to the Comparative Example are shown in FIG. 8, and the results of the coin cell according to the Example are shown in FIG. 9. In the case of the Example, in order to ensure repeatability, two coin cell samples were manufactured using the same manufacturing method.

Referring to FIG. 8, it was confirmed that the coin cell including the anode according to the Comparative Example, in which pre-lithiation was not performed, showed very unstable behavior in initial cycles and was unable to operate normally in a room temperature environment due to a short circuit. It is expected that this is because lithium is consumed due to the γ₃ phase Li—Ag alloy, which is formed irreversibly, during initial charging and discharging.

Referring to FIG. 9, it was confirmed that both Sample 1 and Sample 2 including the pre-lithiated anode according to the Example operated stably at room temperature. In addition, referring to FIG. 10, which shows coulombic efficiencies of Sample 1 and Sample 2 depending on repeated charge and discharge cycles, it was confirmed that the alloying reaction and the electrodeposition/desorption reaction simultaneously occur in initial cycles, but as the cycle is repeated, the efficiency continues to increase and the Samples behave metallically. It is expected that this is because an initial irreversible reaction was minimized through the pre-lithiation.

As is apparent from the above description, in a manufacturing method of a pre-lithiated anode for all-solid-state batteries according to embodiments of the present disclosure, a coating layer including a γ₃ phase Li—Ag alloy is formed through pre-lithiation of an intermediate layer including silver (Ag) particles and a carbon material.

In the manufacturing method according to embodiments of the present disclosure, the γ₃ phase Li—Ag alloy, which is irreversibly formed, is formed through pre-lithiation before assembling an all-solid-state battery, and then, the coating layer including the γ₃ phase Li—Ag alloy is interposed between an anode current collector and a solid electrolyte layer when assembling the all-solid-state battery, thereby being capable of minimizing an irreversible reaction in the initial charge/discharge cycles. Accordingly, the initial cycle efficiency and coulombic efficiency of the all-solid-state battery may be improved.

Particularly, the initial cycle efficiency and coulombic efficiency of the all-solid-state battery may be improved by controlling phase transition of the Li—Ag alloy to the γ₃ phase by performing pre-lithiation while applying a pressure of 0.01 MPa to 0.1 MPa.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of manufacturing a pre-lithiated anode, the method comprising:
preparing an anode assembly comprising an anode current collector and an intermediate layer disposed on a surface of the anode current collector, wherein the intermediate layer comprises silver particles and a carbon material;
applying an electrolyte solution to the intermediate layer;
manufacturing a pressurization structure by stacking a lithium supply layer on the intermediate layer coated with the electrolyte solution; and
performing pre-lithiation to convert the intermediate layer into a coating layer by applying pressure to the pressurization structure in a stacking direction thereof to form the pre-lithiated anode, wherein the coating layer comprises a γ₃ phase Li—Ag alloy formed by reacting the silver particles with lithium in performing the pre-lithiation.

2. The method of claim 1, wherein the electrolyte solution comprises a lithium salt and an organic solvent.

3. The method of claim 2, wherein the lithium salt comprises a compound selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

4. The method of claim 2, wherein the organic solvent comprises a solvent selected from the group consisting of an ester-based solvent, an ether-based solvent, a ketone-based solvent, an aromatic hydrocarbon-based solvent, a carbonate-based solvent, an alcohol-based solvent, a nitrile-based solvent, an amide-based solvent, a dioxolane-based solvent, a sulfolane-based solvent, and combinations thereof.

5. The method of claim 1, wherein an area of the lithium supply layer is greater than an area of the anode assembly.

6. The method of claim 1, wherein the pressure applied to the pressurization structure is 0.01 MPa to 0.1 MPa.

7. The method of claim 1, wherein the pre-lithiation is performed for 5 hours or more but less than 10 hours.

8. The method of claim 1, wherein the pre-lithiation is performed for 5 hours to 7 hours.

9. The method of claim 1, wherein the pre-lithiation is performed at room temperature.

10. The method of claim 1, wherein the γ₃ phase Li—Ag alloy is represented by LiₓAg, wherein x is 1.98 to 2.25.

11. The method of claim 1, wherein the γ₃ phase Li—Ag alloy is irreversibly formed.

12. The method of claim 1, wherein the coating layer does not comprise a γ₂ phase Li—Ag alloy or a γ₁ phase Li—Ag alloy.

13. The method of claim 1, wherein the carbon material comprises a material selected from the group consisting of a particulate carbon material, a fibrous carbon material, and a combination thereof.

14. The method of claim 1, further comprising, after performing the pre-lithiation:
collecting the pre-lithiated anode comprising the anode current collector and the coating layer;
removing remaining impurities from the pre-lithiated anode with a washing solvent; and
drying the pre-lithiated anode from which the impurities have been removed.

15. An all-solid-state battery comprising:
the pre-lithiated anode prepared according to the method of claim 1;
a solid electrolyte layer disposed on the pre-lithiated anode, the solid electrolyte layer comprising a solid electrolyte; and
a cathode disposed on the solid electrolyte layer, the cathode comprising a cathode active material layer and a cathode current collector.

16. A method of manufacturing an all-solid state battery, the method comprising:
manufacturing a pre-lithiated anode, wherein manufacturing the pre-lithiated anode comprises:
preparing an anode assembly comprising an anode current collector and an intermediate layer disposed on a surface of the anode current collector, wherein the intermediate layer comprises silver particles and a carbon material;
applying an electrolyte solution to the intermediate layer;
manufacturing a pressurization structure by stacking a lithium supply layer on the intermediate layer coated with the electrolyte solution; and
performing pre-lithiation to convert the intermediate layer into a coating layer by applying pressure to the pressurization structure in a stacking direction thereof to form the pre-lithiated anode, wherein the coating layer comprises a γ₃ phase Li—Ag alloy formed by reacting the silver particles with lithium in performing the pre-lithiation;
disposing a solid electrolyte layer on the pre-lithiated anode; and
disposing a cathode on the solid electrolyte layer, the cathode comprising a cathode active material layer and a cathode current collector.

17. The method of claim 16, wherein:
the electrolyte solution comprises a lithium salt and an organic solvent;
the lithium salt comprises a compound selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof; and
the organic solvent comprises a solvent selected from the group consisting of an ester-based solvent, an ether-based solvent, a ketone-based solvent, an aromatic hydrocarbon-based solvent, a carbonate-based solvent, an alcohol-based solvent, a nitrile-based solvent, an amide-based solvent, a dioxolane-based solvent, a sulfolane-based solvent, and combinations thereof.

18. The method of claim 16, wherein:
the pressure applied to the pressurization structure is 0.01 MPa to 0.1 MPa; and
the pre-lithiation is performed at room temperature for 5 hours or more but less than 10 hours.

19. The method of claim 16, wherein the γ₃ phase Li—Ag alloy is represented by LiₓAg, wherein x is 1.98 to 2.25.

20. The method of claim 16, wherein the coating layer does not comprise a γ₂ phase Li—Ag alloy or a γ₁ phase Li—Ag alloy.
